(19) United States
(12) Patent Application Publication
(10) Pub. No.: US 2016/0107399 A1
(43) Pub. Date: Apr. 21, 2016

(54) APPARATUS FOR MANUFACTURING COMPOSITE LEAF SPRING

(71) Applicant: Research Institute of Medium & Small Shipbuilding, Busan (KR)

(72) Inventors: Yong Won KWON, Busan (KR); Hong Kwon LEE, Jinju-si (KR)

(21) Appl. No.: 14/872,421

(22) Filed: Oct. 1, 2015

(30) Foreign Application Priority Data
Oct. 20, 2014 (KR) 10-2014-0141892

(51) Int. Cl. B29C 70/46; B29C 33/42; B29C 35/08; B29C 70/54; B29C 70/56

(52) U.S. Cl. CPC B29C 70/46; B29C 70/546; B29C 70/56; B29C 35/0805; B29C 33/42; B29K 2105/101

(57) ABSTRACT

An apparatus for manufacturing a composite leaf spring, including: a supply roller configured to wind a reinforcing fiber on an outer circumference thereof; a resin impregnation unit configured to supply a synthetic resin to the reinforcing fiber withdrawn from the supply roller; a polyprism-shaped rotating mold unit rotatably disposed at one side of the resin impregnation unit, and having molding grooves formed along an outer surface in a circumferential direction thereof to be in communication with each other and disposed in multiple rows; and a supply arm including a withdrawing means configured to protrude to one side of the resin impregnation unit and to withdraw the reinforcing fiber, and an elastic guide configured to guide the reinforcing fiber to each of the molding grooves.

This application claims the benefit of Korean Application No. 10-2014-141892 which was filed on Oct. 20, 2014, which was hereby incorporated by reference as if fully set forth herein.

### BACKGROUND OF THE INVENTION

1. Field of the Invention

The present invention relates to an apparatus for manufacturing a composite leaf spring, and more particularly, to an apparatus for manufacturing a composite leaf spring, which enhances productivity and quality by continuously and accurately stacking multilayers formed of a reinforced material in which a resin is impregnated.

2. Background of the Related Art

Generally, a leaf spring is formed by overlapping a plurality of plate bodies, each of which is formed to have a predetermined thickness and a semielliptical grade, to provide an elastic force, and provided between a vehicle body and an axle to serve as a shock-absorbing device.

At this time, the leaf spring was formed by mechanically fastening a plurality of metal plates. However, in the case of the metal plate, there was a problem in that a defect occurred by fatigue failure due to a long-term use, or by corrosion due to salt humidity in the winter.

Also, recently, interest in manufacturing of a leaf spring using a composite material for a weight reduction of a vehicle as a measure to deal with problems of the rise of environmental issues and the reinforcement of exhaust gas regulation of the vehicle is being increased. Here, the composite material is a material having a variety of components in which a basic matrix such as polymer, metal, carbon and ceramic is reinforced with fiber or thread-shaped crystals, fine dispersoids or the like.

In particular, since fiber-reinforced plastic (FRP) having a high stiffness and a light weight is suitable for a material of the leaf spring for a vehicle. At this time, the FRP includes glass fiber-reinforced plastic (GFRP) in which glass fiber is used as a reinforcing material, and carbon fiber-reinforced plastic (CFRP) in which carbon fiber is used as the reinforcing material. At this time, the FRP has a very different molding time according to a basic resin and a molding process. However, a short molding cycle is essential for an industrial field, such as motor vehicle industry, which needs a mass production system.

Meanwhile, in the related art, a fabric type fiber is put on a surface of a mold, and then an operator impregnates an inside of stacked fibers with a resin using a roller and a brush and forms one layer. Such a layer is pressed to induce a plastic deformation thereof, while staked in multilayers, and then hardened through a heat treatment, thereby being manufactured as one leaf spring.

However, due to a period of time for manually forming each layer and then stacking the layer in multilayers, it is impossible to construct the mass production system, and also since a time when each layer is exposed to air is long, durability of a product is reduced.

Furthermore, it is difficult that the resin and the fiber material are impregnated at an optimal ratio, and also a thickness of each layer stacked on the surface of the mold is not uniform. Therefore, it is difficult to stack each formed layer in an accurate shape, and thus to properly realize an elastic force and a stiffness of the product according to an initial design.

### SUMMARY OF THE INVENTION

In accordance with one aspect of the present invention, an apparatus for manufacturing a composite leaf spring includes a supply roller configured to wind a reinforcing fiber on an outer circumference thereof; a resin impregnation unit configured to supply a synthetic resin to the reinforcing fiber withdrawn from the supply roller; a polyprism-shaped rotating mold unit rotatably disposed at one side of the resin impregnation unit, and having molding grooves formed along an outer surface in a circumferential direction thereof to be in communication with each other and disposed in multiple rows; and a supply arm including a withdrawing means configured to protrude to one side of the resin impregnation unit and to withdraw the reinforcing fiber, and an elastic guide configured to guide the reinforcing fiber to each of the molding grooves, such that the reinforcing fiber is stacked at an inside of each of the molding grooves and thus a fiber-reinforced resin layer is formed when the rotating mold unit is rotated.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a perspective view of an apparatus for manufacturing a composite leaf spring according to one embodiment of the present invention;

FIG. 2 is a side view of the apparatus for manufacturing the composite leaf spring according to one embodiment of the present invention;

FIG. 3 is a plan view of the apparatus for manufacturing the composite leaf spring according to one embodiment of the present invention;

FIG. 4 is a perspective view of an apparatus for manufacturing the composite leaf spring according to another embodiment of the present invention; and

FIG. 5 is an exemplary view of an apparatus for manufacturing the composite leaf spring according to still another embodiment of the present invention.

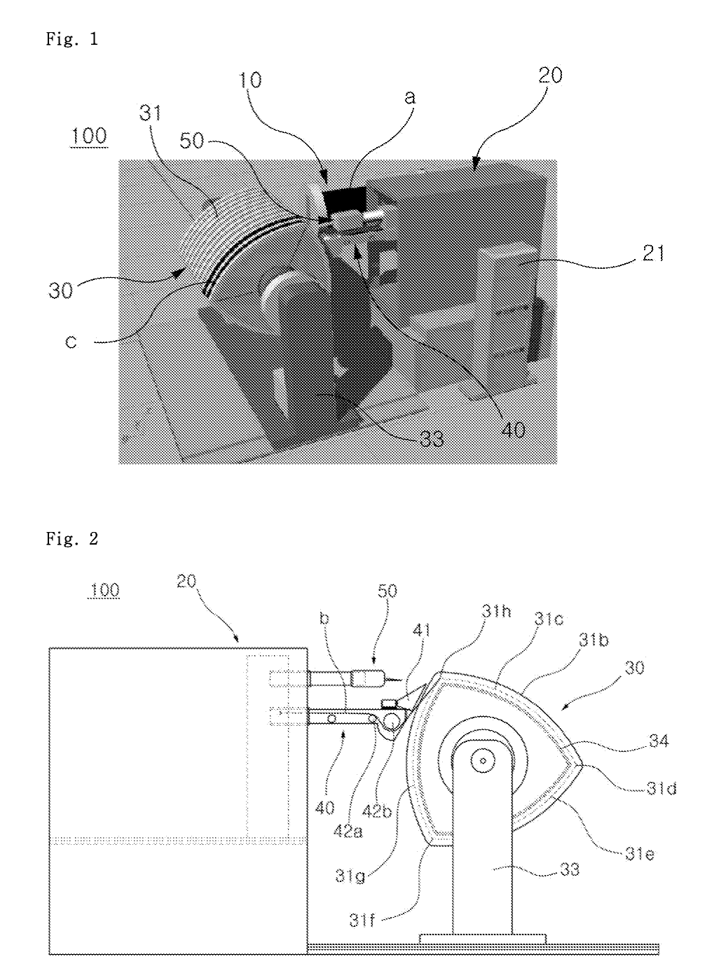

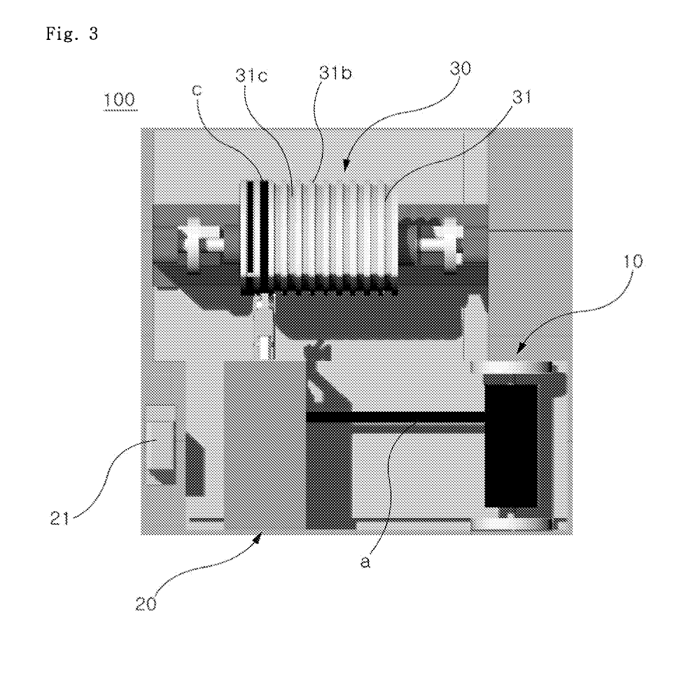

### DETAILED DESCRIPTION OF THE PREFERRED EMBODIMENT

Hereinafter, exemplary embodiments of the present invention will be described with reference to the accompanying drawings. Throughout the disclosure, like reference numerals refer to like parts throughout the various figures and embodiments of the present invention, and repeated description thereof will be omitted.

As illustrated in FIGS. I to 3, an apparatus 100 for manufacturing a composite leaf spring according to one embodiment of the present invention includes a supply roller 10, a resin impregnation unit 20, a rotating mold unit 30, and a supply arm 40.

Here, in the apparatus 100 for manufacturing the composite leaf spring, a reinforcing fiber a wound on the supply roller 10 is withdrawn, and a synthetic resin is supplied to the withdrawn reinforcing fiber a through the resin impregnation unit 20. Also, in the apparatus 100 for manufacturing the composite leaf spring, a reinforcing fiber b impregnated with the synthetic resin is guided to and stacked on a molding groove 31.

The composite is a material in which a basic matrix such as polymer, metal, carbon and ceramic is reinforced with fiber or thread-shaped crystals, fine dispersoids or the like. It may be understood that the composite is glass fiber-reinforced plastic (GFRP) in which a synthetic resin is reinforced with glass fiber to be suitable for weight-lightening of a vehicle or a ship, or carbon fiber-reinforced plastic (CFRP) in which the synthetic resin is reinforced with carbon fiber.

At this time, the reinforcing fiber b in which the synthetic resin is impregnated is stacked at the inside of the molding groove 31 according to rotation of the rotating mold unit 30, and thus a fiber-reinforced resin layer c may be formed. The fiber-reinforced resin layer c is stacked in multilayers according to the repeated rotation of the rotating mold unit 30, and thus the leaf spring may be manufactured.

Meanwhile, the supply roller 10 has a circular roller structure on which the reinforcing fiber such as the glass fiber and the carbon fiber is wound, and the reinforcing fiber a may be provided in various types such fabric, knitted or twilled fabric, and filament. At this time, a width of the reinforcing fiber may be provided corresponding to a width of the molding groove 31 formed at the rotating mold unit 30.

And a shape of the molding groove 31 may be determined according to a width and a thickness of a final product, and the molding groove 31 may be formed based on the leaf spring which typically has a width of 75 mm, a thickness of 30 mm, and a stacked structure of 60 plies.

A rotating shaft of the supply roller 10 may be disposed in parallel with the ground. And the rotating shaft of the supply roller 10 is may be connected with a separate rotational driving means, and may unwind the wound reinforcing fiber corresponding to a withdrawing speed of the reinforcing fiber through the supply arm 40. At this time, the rotating shaft may be rotated by a pulling force generated when the reinforcing fiber is withdrawn by the supply arm 40 without the separate rotational driving means.

Meanwhile, the resin impregnation unit 20 supplies a synthetic resin to the reinforcing fiber a withdrawn from the supply roller 10. Here, the synthetic resin may be an unsaturated polyester resin which is a thermosetting resin. At this time, the unsaturated polyester resin includes a modified bisphenol-based resin, a bisphenol-based resin, an iso-based resin, an ortho-based resin, a tere-based resin, and a vinylester-based resin.

Specifically, a resin bath may be provided at an inside of the resin impregnation unit 20, and the synthetic resin which is plasticized may be supplied to the resin bath to be filled in the resin bath at a predetermined height. At this time, one pair of impregnating rollers is provided at the resin bath to be rotated while lower portions thereof are submerged in the plasticized synthetic resin, and pressing rollers are provided up and down at a front side of the pair of impregnating rollers. Therefore, the reinforcing fiber in which the synthetic resin is impregnated is pressed between outer surfaces of the pressing rollers.

Here, the reinforcing fiber conveyed to the inside of the resin impregnation unit 20 passes through an upper portion of one impregnating roller and a lower portion of the other impregnating roller, and is submerged in the synthetic resin located in the resin bath, and thus the synthetic resin may be supplied to the reinforcing fiber. While the reinforcing fiber to which the synthetic resin is supplied passes between the pressing rollers which are disposed up and down, the synthetic resin may be uniformly spread and impregnated in the reinforcing fiber.

Therefore, the reinforcing fiber and the synthetic resin may be stacked along an outer surface of the rotating mold unit 30 at a uniform ratio, and form the fiber-reinforced resin layer c. And when each fiber-reinforced resin layer which is stacked in multilayers to form the leaf spring is heated and cured, a deformation thereof due to a difference of a volume or a density between the layers may be minimized, and thus high quality products having high stability and elasticity may be manufactured.

An operation panel 21 is provided at the resin impregnation unit 20, and an operator may control start and stop of the withdrawing of the reinforcing fiber through the rotation of the rotating mold unit 30 or the supply arm 40 using the operation panel 21.

Meanwhile, the rotating mold unit 30 may be formed in a polyprism shape, and disposed at one side of the resin impregnation unit 20 to be rotatable. The molding grooves 31 formed to be in communication with each other in an outer circumferential direction of the rotating mold unit 30 are partitioned and disposed in multiple rows.

Here, the rotating mold unit 30 may be formed in a triangular prism shape in consideration of a curing speed of the synthetic resin, a length of the leaf spring, and a withdrawing and stacking speed of the reinforcing fiber. Of course, the rotating mold unit may be formed in various polyprism shapes such as a square pillar and a pentagonal prism.

The molding grooves 31 formed at each surface of the rotating mold unit 30 are provided to be in communication with each other in the circumferential direction, and thus when the rotating mold unit 30 is rotated, the reinforcing fiber may be continuously supplied to one molding groove 31 and stacked in multilayers without a separate operation. Also, a center portion of each surface of the rotating mold unit 30 may protrude to be rounded and thus may have a curved surface similar to a curvature of an inner surface of the leaf spring.

At this time, the rotating mold unit 30 may be provided so that each surface forming the polyprism has a uniform surface area, and the rotating shaft of the rotating mold unit 30 may be disposed in parallel with the ground, and may be connected to upper ends of one pair of mold support units 33.

When the rotating mold unit 30 is rotated, each surface of the rotating mold unit 30 may be opposed, in turn, to one side of the resin impregnation unit 20. Here, one molding groove 31 is formed along the outer surface of the rotating mold unit 30 in the circumferential direction to be in communication with each other along each surface of the rotating mold unit 30. At this time, the molding groove 31 is disposed in multiple rows in a direction of the rotating shaft of the rotating mold unit 30, and thus a plurality of molding grooves 31 having the same shapes may be formed at the outer surface of the rotating mold unit 30.

The supply arm 40 includes withdrawing means 42a and 42b and an elastic guide 41. The supply arm 40 supplies the reinforcing fiber b, which is withdrawn from the supply roller 10, passes through the resin impregnation unit 20 and to which the synthetic resin is supplied, to each molding groove 31 of the rotating mold unit 30.

At this time, the supply arm 40 protrudes to one side of the resin impregnation unit 20. That is, the supply arm 40 may be formed to protrude to one side in which the rotating mold unit 30 is disposed, and to support the reinforcing fiber passing through the resin impregnation unit 20.

Here, the withdrawing means 42a and 42b configured with a plurality of conveying rollers disposed in a conveying direction of the reinforcing fiber may be provided at an inside of the supply arm 40. That is, the conveying rollers may be disposed in multiple rows in a protruding direction of the supply arm.

Specifically, the conveying rollers include a first conveying roller 42a which is rotated while being in contact with a lower surface of the reinforcing fiber, and a second conveying roller 42b which is provided to have a larger diameter than that of the first conveying roller 42a, and rotated while being in contact with an upper surface of the reinforcing fiber. At this time, the second conveying roller 42b may be connected to a driving motor to be rotatable. Here, a plurality of first conveying rollers may be provided and disposed to be spaced at regular intervals and to be freely rotated without a separate driving source.

That is, the reinforcing fiber passing through the resin bath may be conveyed to an end side of the supply arm 40 along an upper portion of the first conveying roller 42a, may pass through the second conveying roller 42b to cover a lower portion of the second conveying roller 42b, and then may be fixed to one side of the rotating mold unit 30.

At this time, the second conveying roller 42b may be rotated at a constant speed, and may push and withdraw the reinforcing fiber toward the rotating mold unit 30. The rotating mold unit 30 may be rotated corresponding to a speed of the reinforcing fiber withdrawn from the supply arm 40, and thus the molding groove 31 may be coated with the reinforcing fiber.

Here, the second conveying roller 42b may be provided to have a large diameter which maximizes a contact surface with the reinforcing fiber, and thus the reinforcing fiber may be smoothly withdrawn through rotation of the second conveying roller 42b. The second conveying roller 42b may be controlled to be rotated at a constant speed, such that each part of the reinforcing fiber is impregnated with the synthetic resin in the resin bath for a uniform period of time.

At this time, the withdrawing speed of the reinforcing fiber according to the rotation of the second conveying roller 42b may be set differently according to a material and a shape of an outer surface of the reinforcing fiber. That is, when the filament forming the reinforcing fiber has high wettability, it may be set to have a rapid withdrawing speed, and when the filament has low wettability, it may be set to have a slow withdrawing speed, such that an impregnation time is increased, and thus the synthetic resin is sufficiently supplied to the reinforcing fiber.

Also, the elastic guide 41 is provided at a side end of the rotating mold unit 30 of the supply arm 40 to elastically press the reinforcing fiber which is withdrawn from the supply arm 40 and inserted into one side of the molding groove 31.

That is, since the rotating mold unit 30 is provided in the polyprism shape of which each surface is rounded, a distance between an end of the supply arm 40 and an inside of the molding groove 31 in which the reinforcing fiber is stacked may be changed, when the rotating mold unit 30 is rotated along the rotating shaft. At this time, the elastic guide 41 guides the reinforcing fiber b to be inward in close contact with each other by elastically pressing the upper surface of the reinforcing fiber b toward the rotating mold unit 30.

Therefore, the reinforcing fiber stacked along the molding groove 31 may be tightly stacked regardless of a change in the distance between the end of the supply arm 40 and the inside of the molding groove 31 in which the reinforcing fiber is stacked. Thus, a surface of each fiber-reinforced resin layer c stacked at the inside of the molding groove 31 may be evenly formed without concave or convex portion and deformation, and the fiber-reinforced resin layers c stacked in multilayers may be uniformly combined with each other.

And when the leaf spring is elastically deformed, an applied external force is uniformly distributed to a plurality of fiber-reinforced resin layers c which are in contact with each other, and thus it is possible to manufacture the leaf spring in which the elastic force may be stably provided, and a damage due to a concentration of the external force may be minimized.

Meanwhile, the molding groove 31 includes a plurality of forming surfaces 31c, 31e and 31g which have a profile corresponding to a predetermined curvature of a lower surface of the leaf spring, and a partition plate 31b is formed at both sides of each molding groove 31 to protrude in the circumferential direction of the rotating mold unit 30. For example, a bottom surface of the molding groove 31 is formed by three forming surfaces 31c, 31e and 31g which are divided by each corner 31d, 31f, 31h of the rotating mold unit 30, and each of the forming surfaces may be formed to have a profile corresponding to the predetermined curvature of the lower surface of the leaf spring.

Here, the number of the forming surfaces 31c, 31e and 31g is provided to correspond to the number of surfaces of the polyprism, and the number of leaf springs corresponding to the number of forming surfaces 31c, 31e and 31g may be manufactured at a time in one molding groove 31. Therefore, when the overall inside of each molding groove 31 disposed in multiple rows in the direction of the rotating shaft of the rotating mold unit 30 is filled with the fiber-reinforced resin layers c, the number of leaf springs corresponding to multiplication of the number of the molding grooves 31 and the number of forming surfaces in the molding groove 31 are manufactured at a time, and thus productivity of the leaf spring is further enhanced.

At this time, a cutting unit 50 which cuts the fiber-reinforced resin layer c stacked on the molding groove 31 may be provided at the supply arm 40. The cutting unit 50 may be withdrawn toward each corner of the molding groove 31, and may cut the fiber-reinforced resin layer c corresponding to the number of the molding grooves 31 of the rotating mold unit 30. Here, each of the cut leaf springs is formed to have a curvature set according to a profile of the forming surface of the molding groove 31. Therefore, since a complete product may be manufactured through only a heat curing process without a separate forming process, the productivity of the product may be improved through simplification of the process.

Since the molding grooves 31 disposed in multiple rows in the direction of the rotating shaft of the rotating mold unit 30 are divided by the partition plate 31b, a separate process in which the fiber-reinforced resin layer c is cut along a width of the leaf spring is not needed. That is, since the fiber-reinforced resin layer c formed in one molding groove 31 is clearly divided from another fiber-reinforced resin layer stacked in another molding groove, the productivity may be improved through the simplification of the process.

Also, since the partition plate 31b is formed to protrude from both sides of each molding groove 31, the plurality of fiber-reinforced resin layers c may be stacked along the molding grooves 31 to be accurately aligned.

Further, each fiber-reinforced resin layer c may be pre-cured by a heating means, and may be integrally formed when stacked, and thus the manufacturing process may be simplified, and also, the quality of the product may be improved. That is, a process in which each fiber-reinforced resin layer c is separately formed and then stacked, and a process in which the separated fiber-reinforced resin layers c are combined with each other may be eliminated, and thus the productivity of the product may be improved. Accordingly, each layer of the leaf spring formed in multilayers may be accurately manufactured, and also the manufacturing process may be simplified, and thus a synergy effect in which the quality of the product and the productivity are improved at the same time may be provided.

Meanwhile, a heating means 34 which heats a bottom surface and side surfaces of each molding groove 31 to supply curing heat corresponding to a pre-curing temperature of the synthetic resin may be provided at an inside of the rotating mold unit 30. Here, the heating means 34 may be configured with an electric heating wire or the like, and may be buried along the bottom surface and the side surfaces of the molding groove 31.

At this time, the heating means 34 may heat the rotating mold unit 30 at a predetermined temperature, when the rotating mold unit 30 is rotated, and may supply the curing heat corresponding to the pre-curing temperature of the synthetic resin. A heating temperature of the heating means 34 may be differently set according to types of the synthetic resin. In the case of the unsaturated polyester resin, the heating temperature of the heating means 34 may be set to 75 to 85° C., more preferably, 80° C.

At this time, since the heating means 34 provides the curing heat corresponding to the pre-curing temperature, the synthetic resin injected into the inside of the molding groove 31 and the reinforcing fiber may be fixed at the moment when stacked. Therefore, a shape of the fiber-reinforced resin layer c stacked at the lower portion is not deformed by pressing of the reinforcing fiber which is subsequently stacked by the rotation of the rotating mold unit 30, but may be maintained to have a shape matched with an inner surface of the molding groove 31. As described above, since each fiber-reinforced resin layer c may be stacked in multilayers to have a uniform thickness, the leaf spring which is realized to have the designed elastic force and rigidity may be manufactured, and thus reliability of the product may be enhanced.

Here, when the heating temperature of the heating means 34 is less than 75° C., the fixing between the reinforcing fiber and the synthetic resin may not be firmly achieved, and thus when the follow-up reinforcing fiber is stacked, the lower fiber-reinforced resin layer may be deformed. And when the heating temperature of the heating means 34 is more than 85° C., the curing of the synthetic resin is excessively achieved, and thus the combining between the fiber-reinforced resin layers may not be sufficiently achieved, and the fiber-reinforced resin layers may be easily separated from each other.

Meanwhile, the supply arm 40 may be provided to be horizontally moved in the direction of the rotating shaft of the rotating mold unit 30. Specifically, the supply arm 40 may be disposed at a first molding groove of the rotating mold unit 30 to fill the first molding groove with the reinforcing fiber and the synthetic resin, and then may be horizontally moved to a second molding groove. And the horizontal movement process may be repeated until the supplying of the reinforcing fiber and the synthetic resin into the inside of the last molding groove is completed.

Therefore, a process in which the fiber-reinforced resin layer c is formed at all of the molding grooves by supplying the reinforcing fiber and the synthetic resin into each molding groove of the rotating mold unit 30 may be continuously performed.

Meanwhile, the rotating mold unit 30 may be rotatably connected to the driving motor of which a rotating speed is controlled by a control unit, and the rotating speed of the driving motor may be controlled to correspond to the withdrawing speed of the reinforcing fiber b supplied by a withdrawing means of the supply arm 40. At this time, as RPM of the rotating mold unit 30 is increased, the rotating speed of the driving motor may be reduced at a predetermined ratio so that each fiber-reinforced resin layer c is coated with a uniform pressure.

That is, when the thickness of the fiber-reinforced resin layer c increases according to the RPM of the rotating mold unit 30, the rotating speed of the driving motor may be reduced correspondingly. Here, the withdrawing speed of the reinforcing fiber supplied by the withdrawing means of the supply arm 40 is set according to a material of the reinforcing fiber. The withdrawing speed may be set to be rapid, as the wettability of the reinforcing fiber increases.

At this time, when the rotating mold unit 30 is rotated, and the reinforcing fiber is stacked at the inside of the molding groove 31, an area which is coated with the reinforcing fiber is increased due to the fiber-reinforced resin layer c formed at the inside of the molding groove 31. That is, a surface area of the fiber-reinforced resin layer c stacked on the bottom surface of the molding groove 31 is larger than an area of the bottom surface of the molding groove 31, and as more fiber-reinforced resin layers c are stacked, the surface area on which the reinforcing fiber is stacked is increased.

Therefore, when the rotating mold unit 30 is rotated at the constant speed in a state in which the withdrawing speed of the reinforcing fiber is constant, the thickness of each fiber-reinforced resin layer c may be non-uniformly formed due to an increase of a coating area of the reinforcing fiber. This is because a pressure applied to the lower fiber-reinforced resin layer c is increased in the coating process.

Therefore, it is preferable that the rotating speed of the driving motor is controlled to be gradually reduced according to the RPM of the rotating mold unit 30. Accordingly, a pressure when the reinforcing fiber is coated on the inner surface of the molding groove 31 and when the reinforcing fiber is coated at an upper portion of the fiber-reinforced resin layer c is uniformly maintained, and each of the fiber-reinforced resin layers c is formed to have the uniform thickness, and thus the quality of the product may be enhanced.

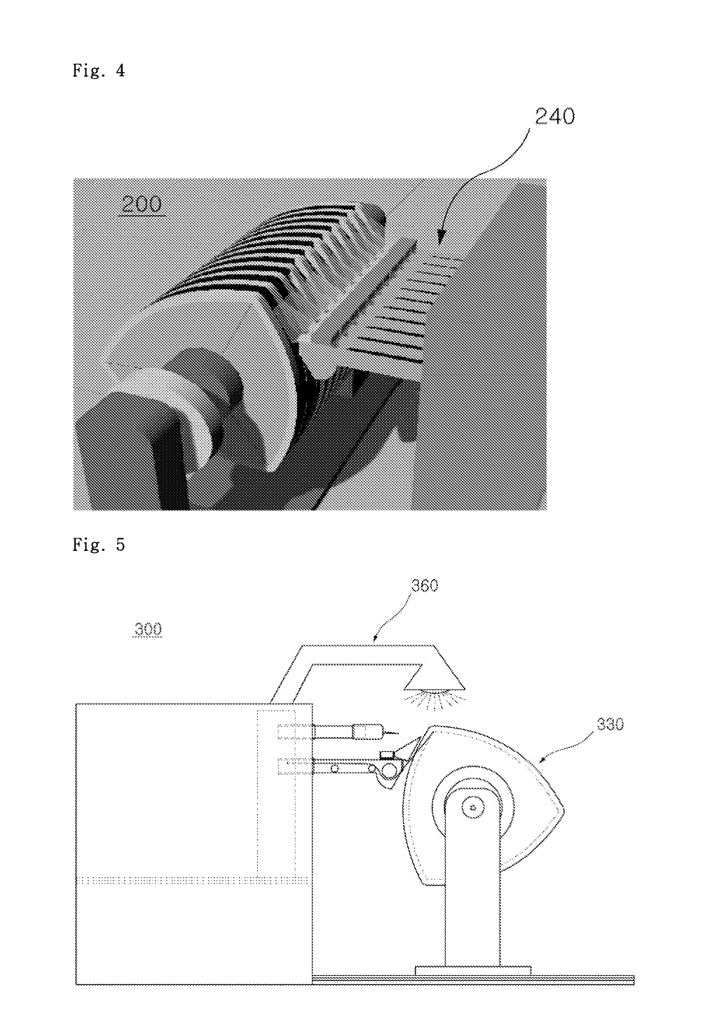

FIG. 4 is an exemplary view of an apparatus for manufacturing the composite leaf spring according to another embodiment of the present invention. In the embodiment, since a basic structure is the same as that of the above-described one embodiment, except that a supply arm is provided in multiple rows, detailed description thereof will be omitted.

As illustrated in FIG. 4, a supply arm 240 may be provided in multiple rows corresponding to the number of the molding grooves. Therefore, when the rotating mold unit is rotated, the reinforcing fiber and the synthetic resin are simultaneously supplied at all of the molding grooves provided in multiple rows in the direction of the rotating shaft of the rotating mold unit. Thus, since a plurality of fiber-reinforced resin layers may be formed by one process, the productivity of the product may be remarkably enhanced.

FIG. 5 is an exemplary view of an apparatus for manufacturing the composite leaf spring according to still another embodiment of the present invention. In the embodiment, an infrared heating unit is provided above the rotating mold unit.

As illustrated in FIG. 5, a infrared heating unit 360 which heats the fiber-reinforced resin layer exposed through an opened portion of each molding groove may be provided above a rotating mold unit 330.

Here, the infrared heating unit 360 may heat the fiber-reinforced resin layer with curing heat corresponding to the pre-curing temperature of the synthetic resin. At this time, the infrared heating unit 360 may supply the curing heat to an upper portion of the uppermost fiber-reinforced resin layer of the plurality of stacked fiber-reinforced resin layers.

Accordingly, the synthetic resin and the reinforcing fiber forming each fiber-reinforced resin layer are fixed through the heating means and the infrared heating unit 360. Therefore, the fiber-reinforced resin layer may be accurately formed to have a uniform thickness and a shape matched with the inside of the molding groove without the deformation due to the reinforcing fiber which is sequentially stacked. Since a follow-up heat curing process is performed while the leaf spring manufactured at the inside of the molding groove is pre-cured, the follow-up heat curing process may be more rapidly completed, and the productivity of the product may be enhanced.

Through the above-described structure, the apparatus for manufacturing the composite leaf spring of the present invention provides the following effects.

First, since the molding grooves are formed in multiple rows in the direction of the rotating shaft of the rotating mold unit, and have the plurality of forming surfaces having the profile corresponding to the predetermined curvature of the lower surface of leaf spring, the reinforcing fiber can be stacked in multilayers at the inside of the molding groove, when the rotating mold unit is rotated. Therefore, since the number of products corresponding to multiplication of the number of the molding grooves and the number of forming surfaces in the molding groove can be simultaneously produced at a time, the productivity can be enhanced.

Second, the reinforcing fiber stacked at each molding groove can be separated from another reinforcing fiber stacked at another molding groove through the partition formed to protrude from both sides of each molding groove, and also the reinforcing fiber stacked at the lower portion can be be accurately aligned with the reinforcing fiber stacked at the upper portion. Therefore, while the process in which the stacked resin layers is cut according to a specification width, or the process in which the resin layers are stacked and bonded to each other can be removed, each layer of the leaf spring can be accurately manufactured, and thus the quality and the productivity of the product can be improved at the same time.

Third, when the curing heat corresponding to the pre-curing temperature of the synthetic resin is supplied to the molding groove through the heating means provided at the inside of the rotating mold unit, the synthetic resin and the reinforcing fiber injected in the molding groove can be fixed at the same time when the reinforcing fiber is stacked. Therefore, the fiber-reinforced resin layer stacked at the lower portion is not deformed by pressing of the sequentially stacked reinforcing fiber, but can be stacked to have an accurate thickness, and when the stacking is completed, a curing time after the stacking can be reduced.

As described above, it will be understood that the foregoing description of the present invention is for illustrative purposes only, and that, for ordinary person in the art, various substitutions, alternations and changes can be made without any change in the technical spirit or the essential characteristics of the present invention. Therefore, the above-described embodiments are to illustrate, not to limit the scope of the claims.

What is claimed is:

1. An apparatus for manufacturing a composite leaf spring, comprising:
a supply roller configured to wind a reinforcing fiber on an outer circumference thereof;
a resin impregnation unit configured to supply a synthetic resin to the reinforcing fiber withdrawn from the supply roller;
a polyprism-shaped rotating mold unit rotatably disposed at one side of the resin impregnation unit, and having molding grooves formed along an outer surface in a circumferential direction thereof to be in communication with each other and disposed in multiple rows; and
a supply arm comprising a withdrawing means configured to protrude to one side of the resin impregnation unit and to withdraw the reinforcing fiber, and an elastic guide configured to guide the reinforcing fiber to each of the molding grooves, such that the reinforcing fiber is stacked at an inside of each of the molding grooves and thus a fiber-reinforced resin layer is formed when the rotating mold unit is rotated.

2. The apparatus according to claim 1, wherein each of the molding grooves comprises a plurality of forming surfaces having a profile corresponding to a predetermined curvature of a lower surface of the leaf spring, and a partition configured to protrude in the circumferential direction of the rotating mold unit is provided at both sides of each of the molding grooves.

3. The apparatus according to claim 1, wherein a heating means configured to heat a bottom surface and side surfaces of each of the molding grooves is provided at an inside of the rotating mold unit to supply curing heat corresponding to a pre-curing temperature of the synthetic resin.

4. The apparatus according to claim 1, wherein an infrared heating unit configured to heat the fiber-reinforced resin layer exposed through an opened portion of each of the molding grooves is provided above the rotating mold unit.

5. The apparatus according to claim 1, wherein the rotating mold unit is rotatably connected to a driving motor of which a rotating speed is controlled by a control unit, and the rotating speed of the driving motor is controlled corresponding to a withdrawing speed of the reinforcing fiber supplied by the withdrawing means of the supply arm, and also reduced at a predetermined ratio according to an increase in RPM of the rotating mold unit so that each fiber-reinforced resin layer stacked in multilayers is coated with a uniform pressure.
